(19) United States
(12) Patent Application Publication
(10) Pub. No.: US 2024/0330033 A1
(43) Pub. Date: Oct. 3, 2024

(54) GUEST SECRET PROTECTION FOR VIRTUAL MACHINES

(71) Applicant: Red Hat, Inc., Raleigh, NC (US)

(72) Inventor: Michael Tsirkin, Yokneam lllit (IL)

(21) Appl. No.: 18/193,303

(22) Filed: Mar. 30, 2023

(51) Int. Cl. G06F 9/455

(52) U.S. Cl. CPC G06F 9/45558; G06F 2009/4557; G06F 2009/45587

(57) ABSTRACT

Systems and methods for virtual machine communication in a virtualized environment can include executing, a virtual machine (VM) with an initial cryptographic secret identifying the VM, and creating a snapshot of the VM. They can also include executing one or more duplicate VMs from the snapshot of the VM, and multicasting an interrupt to multiple virtual central processing units (vCPUs) of the one or more duplicate VMs, the interrupt associated with instructions to execute an operation with respect to the initial cryptographic secret.

### BACKGROUND

Virtualization is a computing technique that improves system utilization, decoupling applications from the underlying hardware, and enhancing workload mobility and protection. Virtualization may be realized through the implementation of virtual machines (VMs). A VM is a portion of software that, when executed on appropriate hardware, creates an environment allowing the virtualization of a physical computer system (e.g., a server, a mainframe computer, etc.). The physical computer system is typically referred to as a “host machine,” and the operating system of the host machine is typically referred to as the “host operating system.” A virtual machine may function as a self-contained platform, executing its own “guest” operating system and software applications. Typically, software on the host machine known as a “hypervisor” (or a “virtual machine monitor”) manages the execution of one or more virtual machines, providing a variety of functions such as virtualizing and allocating resources, context switching among VMs, backing up the state of VMs periodically in order to provide disaster recovery and restoration of virtual machines, and so on. A hypervisor may run directly on the server hardware without an operating system beneath it or as an application running under a traditional operating system. A hypervisor may abstract the physical layer and present this abstraction to virtual machines to use, by providing interfaces between the underlying hardware and virtual devices of virtual machines.

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 depicts a high-level diagram of an example system architecture operating in accordance with one or more implementations of the present disclosure;

FIG. 2 is a flow diagram of an example method for protecting a cryptographical secret of a virtual machine, in accordance with one or more implementations of the present disclosure;

FIG. 3 is a flow diagram of an example method for protecting a cryptographical secret of a virtual machine, in accordance with one or more implementations of the present disclosure;

FIG. 4 is a flow diagram of an example method for protecting a cryptographical secret of a virtual machine, in accordance with one or more implementations of the present disclosure;

FIG. 5 depicts a block diagram of a computer system operating in accordance with one or more implementations of the present disclosure;

FIG. 6 depicts a block diagram of an illustrative computing device operating in accordance with one or more implementations of the present disclosure.

### DETAILED DESCRIPTION

Implementations of the disclosure are directed to virtual machine systems for protecting cryptographical secrets in virtual machines.

Various processor architectures support virtualization by providing instructions for facilitating virtual machine execution. In certain implementations, a processor can support executing a hypervisor (also referred to as “virtual machine monitor” or HV) that can function as a host and have complete control of various hardware resources of a host machine (also referred to as “host system”) including the processor. A hypervisor can present a virtual machine with an abstraction of one or more virtual processors as well as other virtual devices. A hypervisor can retain selective control of processor resources, physical memory, interrupt management, input/output (I/O), and networking. Each virtual machine (VM) is a guest software environment that can support a stack that includes operating system (OS) and application software. Each VM can operate independently of other VMs and can use the same interface to the processors, memory, storage, graphics, and I/O provided by the physical platform (i.e., host machine). The software executing in a virtual machine can be executed at the reduced privilege level so that the hypervisor can retain control of platform resources. Thus, in a virtualization environment, an HV runs on a host computer system to create one or more VMs that can be used to run different operating systems and applications independently of the underlying host system. In some systems, to create a VM, the HV can assign one or more virtual central processing units (vCPUs) to the VM, along with other resources such as memory, storage, and network interfaces.

Processor virtualization can be performed by having the hypervisor schedule time slots on one or more physical processors for a virtual machine without dedicating an entire physical processor exclusively to a single virtual machine. Memory virtualization can be achieved by utilizing a page table (PT) which is a data structure that can be used for translating virtual memory addresses to physical memory addresses or for translating guest memory addresses to host memory addresses. Device and input/output (I/O) virtualization can include managing the routing of I/O requests between virtual devices and the shared physical hardware.

Various computer systems can use trusted execution environments (TEEs) to enhance the isolation of data of a computing process from other processes executing on the computer system. A TEE can use hardware-based encryption to encrypt the data of a lower privileged process so that higher privileged computing processes would not have access to the data in an unencrypted form. This enables a lower privileged process to isolate its data from the higher privileged processes even though the higher privileged processes can be responsible for managing the data.

Encrypted virtual machine memory is a technology supported by TEEs, in which guest memory of the virtual machine is protected from the hypervisor through encryption. In most cases, not all of the guest memory needs to be encrypted, so the virtual machine can control which memory is encrypted by means of marking memory as unencrypted or encrypted in guest memory (i.e., guest controlled guest page tables), which can be used by a virtual central processing unit (vCPU) for translation of guest virtual addresses to guest physical addresses. The guest physical addresses may then be translated by the host to host physical addresses.

Cryptographic secrets, such as cryptographic keys, certificates, and other sensitive information, can be used to secure communication and data between VMs, between a VM and an HV, or between the VM and an outside network in a virtualized environment. A cryptographic secret can refer to a bit sequence that can be used to derive cryptographic keys, digital signatures, and other information used for authentication and confidentiality. For example, HVs can use cryptographic keys to sign a VM's configuration and boot image, allowing the VM to trust that the image has not been tampered with. In other instances, an HV can use a certificate to establish an encrypted communication channel between itself and a VM. Similarly, certificates can be used to establish secure communication between VMs, allowing them to securely communicate and exchange data.

Computer systems can use cryptographic functions to encrypt data stored on a storage device. In some examples, the cryptographic function may be performed by a combination of hardware and lower-level code (e.g., firmware) and may use cryptographic keys that may be concealed from higher-level code (e.g., hypervisor). The higher-level executable code may request the data and the hardware may or may not decrypt the data before fulfilling the request for the data. For example, if the data is associated with a VM, then a request by the guest operating system of the virtual machine may be fulfilled with a decrypted version of the data but a request from the hypervisor may be fulfilled with an encrypted version of the data.

Another advantage of virtualization is the ability to create snapshots of VMs. A snapshot is a copy of the VM's state at a particular point in time. The snapshot can include the memory, storage, and CPU state of the VM and can be used to quickly revert the VM to a previous state when needed. Thus, a snapshot can be a point-in-time representation of the virtual machine's state, including the contents of its storage device(s), configuration files, and memory. It can serve a backup of the virtual machine, which can be used to revert the VM to A previous state reflected by the snapshot. In some systems, VM snapshots can be created by the hypervisor and stored either on the same physical storage as the VM or in a different location. To create a snapshot, the hypervisor can stop the VM storage and memory state and can makes a copy of the current state. In some systems, changes made to the virtual machine after the snapshot was taken can be tracked and stored as delta files. When a VM is restored from a snapshot, the HV can combine any delta files with the baseline image to bring the virtual machine back to its latest state. In various virtual systems snapshots can speed up VM startup, fault recover, and other operations. This functionality can be used for testing, debugging, or as a way to maintain a stable environment.

The functionality of snapshotting is often used when cloning or forking VMs. VM cloning or forking is a process in virtualization technology in which a new VM is created as a duplicate of an existing VM. A duplicate VM that is exactly identical with an original VM can be referred to as cloned, while a duplicate VM that has been modified with some differences relative to the original VM can be referred to as forked. The new VM can be an independent copy of the original VM and can run concurrently with the original VM. In some systems, the HV can assign a new unique identifier (e.g., a VMgenID) to the new VM to distinguished from the original VM. This ensures that the new VM is treated as an independent entity and is not confused with the original VM.

However, creating a snapshot of a VM can also pose a security risk. If the VM contains sensitive information, such as cryptographic secrets used for encryption or authentication, then the snapshot may contain this information as well. For example, when a VM is snapshotted and thereafter forked or cloned to create a duplicate VM, the vCPUs of the duplicate VM can initially have the same cryptographic secret as the original VM. This creates a security flaw due to more than one vCPU in multiple VMs having access to the same cryptographic secret.

To address the challenge created by duplicate VMs having an original VM's cryptographic secret, in some systems, the hypervisor sends an interrupt to one of the vCPUs of the clone VM through an Advanced Configuration and Power Interface (ACPI) interface to instruct it to erase the previous cryptographic secret and/or to generate a new cryptographic secret. ACPI refers to an interface specification for power management and configuration of computer hardware in a computer operating system, that defines a standard interface between the operating system and the computer's firmware or BIOS. ACPI allows the operating system (OS) to control power management, configure/identify hardware, and support power-related events such as system sleep, wake, hibernate, and shutdown. For example, an OS can send an ACPI request to the firmware/BIOS for the firmware/BIOS to perform the requested action. The firmware/BIOS can then notify the OS about the result through an interrupt or memory buffer.

In some virtualized systems, the interrupt can be sent to a virtual interrupt controller (VIC) which is a software component that emulates the functionality of a physical interrupt controller. It can manage the flow of interrupts from various devices to the vCPU. For example, when an interrupt request is generated, it can be first sent to a VIC which can determine which vCPU should handle the interrupt and can send a corresponding signal to that vCPU. Each VM can run on a separate instance of an OS, and each instance of the OS can have its own interrupt controller. The VIC can provide the necessary abstraction layer between the virtual machine and the physical interrupt controller. Thus, upon receiving an interrupt request, the VIC can map the interrupt request to a virtual interrupt vector and can communicate with the physical interrupt controller to request that the interrupt be delivered to the appropriate virtual machine. Then the physical interrupt controller can receive the interrupt request and can map the virtual interrupt vector to a physical interrupt vector that corresponds to the CPU executing the virtual machine. the physical interrupt controller can then deliver the interrupt to the CPU, which processes the request to complete the necessary action.

The processing of this request can be performed by an interrupt handler. The interrupt handler is a function that is executed in response to the receipt of an interrupt (a hardware-triggered or a programmable event requesting a processor to pause execution of the current thread and invoke an interrupt service routine (ISR) specified by the hardware or by a parameter of INT instruction). Interrupts can be generated by hardware components such as peripheral devices, and other system components, (e.g., by an HV to a VM through a virtual Interrupt Handler) to signal the operating system that some action is required. The operating system's kernel can use interrupt handlers to manage and respond to these events. For example, a vCPU can receive the interrupt signal from an HV and respond by stopping its current execution to process the interrupt. Then the vCPU can identify the type of interrupt (e.g., by reading the interrupt vector (data) and identifying the corresponding interrupt handler for the interrupt). The vCPU can then transfer control to the interrupt handler, which performs the necessary actions to manage the event that triggered the interrupt (e.g., to erase the previous cryptographic secret and/or to generate a new cryptographic secret).

In some systems, the vCPU can then forward the interrupt with the notification to perform an operation with respect to the cryptographic secret to other vCPUs of the VM. The vCPU can do this through an inter processor interrupt (IPI) signal that is used to communicate between multiple CPUs within a computer system. The IPI can be used to coordinate activities between the CPUs, such as synchronizing their work, exchanging data, or signaling an event. Thus, the IPI signal can be delivered to the recipient vCPU through the system's interconnect and cause the recipient vCPU to handle the IPI signal through its interrupt handler to perform corresponding action.

However, before the other vCPUs receive this interrupt with the notification to perform an operation with respect to the cryptographic secret, they still have access to the previous cryptographic secret, which compromises the security of the system. Additionally, this scenario creates a race condition with respect to the secret of the original VM. In the context of VM security, a race condition occurs when two or more operations are executed concurrently, and their order of execution affects the outcome of the program. Accordingly, the cryptographic secret that is used by the VCPU's of the duplicate VM can depend on whether it performs an operation that accesses the cryptographic secret before or after receiving the notification through the ACPI interface. This can lead to a security vulnerability, as the unintended outcome could allow unauthorized access to sensitive data or systems. To prevent race conditions, proper synchronization mechanisms must be used to ensure that each operation is executed in a deterministic order. For example, some systems check the VM memory for modifications to detect a new VMgenID (a unique identifier for the VM). However, this approach entails rechecking the memory either before or after each time the secret is accessed. It can further entail using memory barriers (i.e., instructions and configurations to slow down and ordering of operations for vCPU) to slow down the vCPUs to make sure that the re-checking operation happens in the correct order relative to the operation of accessing the secret. Accordingly, this approach increases the use of computing resources to such a point so as to be impractical.

Aspects of this disclosure address the above and other deficiencies by enabling the vCPUs of VMs after cloning to obtain new secrets without needing to check the VM memory every time a secret is accessed. In the present disclosure, the race window is closed and multiple vCPUs of a VM (or e.g., multiple duplicate VMs, original VMs) are provided with new secrets. This is achieved by the HV multicasting an interrupt to multiple vCPUs of a clone VM that instructs each vCPUs to erase the previous secret (and/or create a new secret). Instead of sending an interrupt to a single vCPU through the ACPI interface and having that single vCPU propagate the notification via IPI to other vCPUs, the various implementations described herein include technology that multicasts the interrupt through a VIC to multiple vCPUs to have it be handled by their corresponding interrupt handlers. In this manner, the vCPUs can simultaneously erase the old secret or generate a new secret. Thus, the security flaw of more than one vCPU having access to the same secret is eliminated and the race condition is removed.

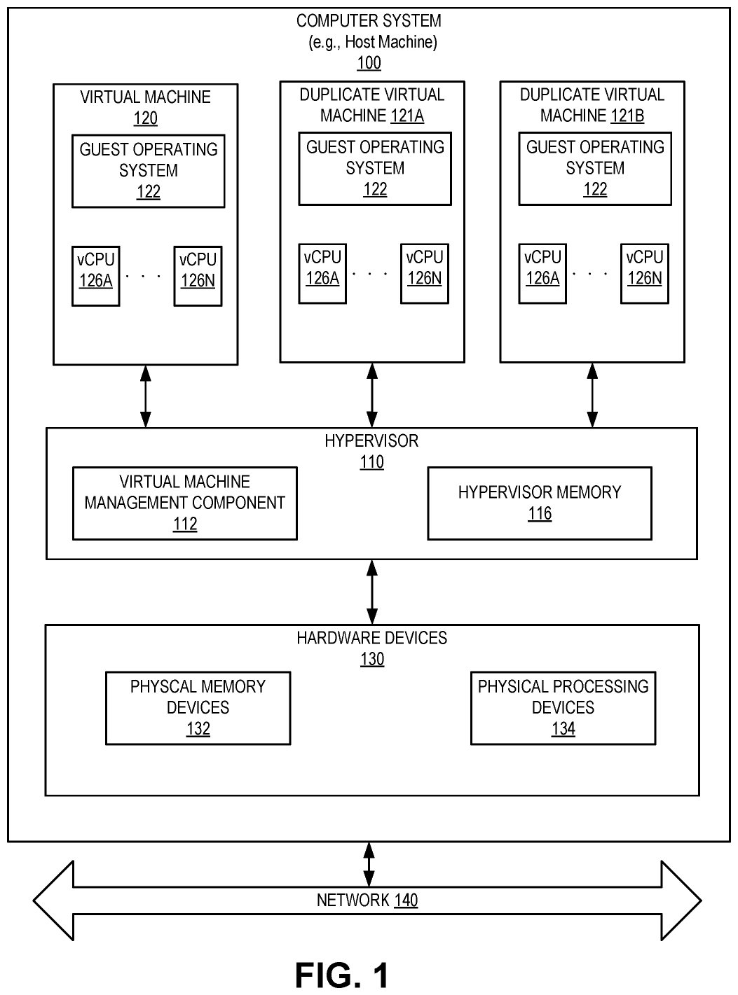

Accordingly, in some implementations of the present disclosure, the hypervisor can execute a virtual machine and assign one or more vCPUs to the virtual machine. This can include the hypervisor executing a VM with an initial cryptographic secret that identifies the VM. The hypervisor can then create a snapshot of the VM. Consequently, having created the snapshot, the hypervisor can execute one or more duplicate VMs from the snapshot of the VM. In some implementations, the hypervisor can multicast an interrupt to multiple vCPUs of one or more of the duplicate VMs. This interrupt can be associated (e.g., in a data structure referenced by an interrupt handler) with instructions to execute an operation with respect to the initial cryptographic secret. In some implementations, additional operations and actions can be performed before the processing logic multicasts the interrupt. These and other benefits of the implementations of the present disclosure can be understood in more detail with reference to FIG. 1.

FIG. 1 depicts an illustrative architecture of elements of a computer system 100, in accordance with an implementation of the present disclosure. It should be noted that other architectures for computer system 100 are possible, and that the implementation of a computer system utilizing embodiments of the disclosure are not necessarily limited to the specific architecture depicted. Computer system 100 can be a single host machine (e.g., host computer system) or multiple host machines that may be arranged in a homogenous or non-homogenous group (e.g., cluster system, grid system, or distributed system). Computer system 100 can include a rackmount server, a workstation, a desktop computer, a notebook computer, a tablet computer, a mobile phone, a palm-sized computing device, a personal digital assistant (PDA), etc. In the implementation depicted in FIG. 1, computer system 100 can include a hypervisor 110, a virtual machine 120, a duplicate virtual machine 121A, 121B, virtual central processing units (vCPUs) 126A, 126N, hardware devices 130, and network 140. For example, system 100 can be connected to a network 140 and comprises physical processing devices 134 (e.g., central processing units (CPUs)), physical memory devices 132, which can include volatile memory devices (e.g., random access memory (RAM)), non-volatile memory devices (e.g., flash memory), and/or other types of memory devices, and storage devices (e.g., a magnetic hard disk, a Universal Serial Bus (USB) solid state drive, a Redundant Array of Independent Disks (RAID) system, a network attached storage (NAS) array, etc.) that can serve as a secondary memory, interconnected as shown.

Computer system 100 can run a host operating system (OS), which can comprise software that manages the hardware resources of the computer system and that can provide functions such as inter-process communication, scheduling, virtual memory management, and so forth. In some implementations, host operating system can run a hypervisor 110, which can provide a virtual operating platform for guest virtual machine (VM) 120 and can manage its execution via the virtual machine management component 112. Virtual machine management component can be understood to perform (and enable the hypervisor to perform) all of the functions of the hypervisor including communication between the VM 120 and hypervisor 110, between a duplicate VM 121A, 121B and hypervisor 110, memory allocation and management, interrupt generation and handling, and communication between VMs. Virtual machine management component 112 can enable hypervisor 110 to configure a virtual machine to use or update a particular cryptographic value. Virtual machine management component 112 can also enable hypervisor 110 to generate, receive, and handle interrupts. In some implementations, each VM can be allocated processing resources by the hypervisor and those resources can include each VM being assigned one or more vCPUs 126A, 126N. Hypervisor 110 can manage virtual machine 120, and duplicate virtual machines 121A, 121B and provide them with access to system resources. Hypervisor 110 can similarly create and manage one or more virtual devices which can correspond to one or more hardware devices 130 or be entirely virtual instances emulating the functions of a device not physically present within computer system 100.

The hypervisor can include hypervisor memory 116 that can be used for performing the various functions of the hypervisor. VM 120 and duplicate VMs 121A, 121B can each be a software implementation of a machine that executes programs as though it were an actual physical machine. VM 120 and duplicate VMs 121A, 121B can each have a corresponding guest operating system 122 that manages virtual machine resources and provides functions such as inter-process communication, scheduling, memory management, etc. Although, for simplicity, a single VM is depicted in FIG. 1, in some other implementations, computer system 100 can comprise multiple VMs.

As shown, hypervisor 110 can include a virtual machine management component that can create and manage the operation of the VM 120 and duplicate VMs 121A, 121B including the execution of programs on the VM and duplicate VMs 121A, 121B including instructions still execute operations with respect to a cryptographic secret. The hypervisor 110 can (e.g., through the virtual machine management component 112) create snapshots of a virtual machine and can access memory locations associated with one or more virtual machines.

Physical processing devices 134 can include one or more processors that are capable of accessing physical memory devices 132 and executing instructions of the guest operating system 122 and of the hypervisor 110. Processing devices 134 can be a single core processor that is capable of executing one instruction at a time (e.g., single pipeline of instructions) or can be a multi-core processor that simultaneously executes multiple instructions. The instructions can encode arithmetic, logical, or I/O operations and can be used to execute a cryptographic function that performs encryption or decryption of data within physical memory devices 132. Processing devices 134 and physical memory devices 132 can interact with one another to store data in an encrypted form and provide access to the stored data in either an encrypted form or unencrypted form based on the context of the process attempting to access the data (e.g., VM process or hypervisor process).

In some implementations, the computer system 100 together with its constituent hardware devices 130 can be communicatively connected to network 140. Network 140 can be a public network (e.g., the internet), a private network (e.g., a local area network (LAN) or wide area network (WAN)), or a combination thereof. In one example, network 140 can include a wired or a wireless infrastructure, which can be provided by one or more wireless communications systems, such as a wireless fidelity (WiFi) hotspot connected with the network 140 and/or a wireless carrier system that can be implemented using various data processing equipment, communication towers, etc.

Accordingly, in some implementations of the present disclosure, the hypervisor 110 (e.g., via the VM management component 112) can create (one or more) VMs 120 120. This can include executing a VM 120 on a host computer system 100 with an initial cryptographic secret that identifies the VM. The hypervisor 110 can assign the VM 120 multiple virtual central processing units (vCPUs) to execute the software processes running on the VM. The initial cryptographic secret can be any type of encryption key, such as a symmetric or asymmetric key, used to secure and authenticate the VM 120 and its associated resources. For example, the initial cryptographic secret can be a randomly generated value that is securely stored and used for subsequent encryption and decryption of data within the VM. The initial cryptographic secret can also be associated with an identifier that uniquely identifies the VM.

In the same or other implementations, the hypervisor 110 can create a snapshot of the VM, which can be a point-in-time copy of the VM's state, including its memory, registers, and other state information. The snapshot can be used to create one or more duplicate VMs 121A, 121B that are exact copies of the original VM 120 or modified versions of the original VM 120 with different cryptographic secrets.

Accordingly, the hypervisor 110 can execute one or more duplicate VMs 121A, 121B from the snapshot of the VM. The duplicate VMs 121A, 121B can be exact copies of the original VM, including its initial cryptographic secret, or modified copies with different cryptographic secrets. The hypervisor 110 can determine, for each vCPU 126A, 126N assigned to the VM, whether the vCPU 126A, 126N is registered to receive an interrupt. This determination can prevent unnecessary overhead caused by multicasting the interrupt to vCPUs 126A, 126N that do not require it or are not capable of properly interpreting it.

In some implementations, the hypervisor 110 can maintain a data structure that tracks which vCPUs 126A, 126N are registered to receive the interrupt. When an interrupt is generated, the hypervisor 110 can consult this data structure to determine which vCPUs 126A, 126N to multicast the interrupt to, based on their registration status. This can help ensure that only the necessary vCPUs 126A, 126N receive the interrupt, while minimizing overhead and resource utilization.

Determining which vCPU 126A, 126N of a group of vCPUs 126A, 126N or whether a particular vCPU 126A, 126N is registered to receive the interrupt can be useful to improve the efficiency of the system by reducing the amount of unnecessary processing and communications that occur. Additionally, the initial cryptographic secret can be used to secure data communications within the VM 120 and can be associated with an identifier that uniquely identifies the VM. The snapshot can be used to create multiple VMs 120 that are exact or modified copies of the original VM. This technology can be used to enable efficient and secure virtualization of computer resources.

Accordingly, the hypervisor 110 can multicast an interrupt to one or more vCPUs 126A, 126N of the one or more duplicate VMs 121A, 121B that were created from the snapshot. In some implementations, the interrupt can be associated with instructions to execute an operation with respect to the initial cryptographic secret. In this manner, the interrupt can be used to modify, erase, or generate a new cryptographic secret. The multicasting of the interrupt can ensure that the operation is executed simultaneously on all vCPUs 126A, 126N that are registered to receive the interrupt, thereby ensuring that the cryptographic secret is updated consistently. For example, responsive to determining that at least two vCPUs 126A, 126N of the vCPUs 126A, 126N that were assigned to a duplicate VM 121A, 121B are registered to receive the interrupt, the hypervisor 110 can multicast the interrupt to those vCPUs. Accordingly, in some implementations, the hypervisor 110 can multicast the interrupt to respective groups of multiple vCPUs 126A, 126N associated with each corresponding duplicate VM 121A, 121B of a set of two or more duplicate VMs. In other implementations, the hypervisor 110 can multicast the interrupt to both (i) one or more vCPUs 126A, 126N associated with the VM 120 and to (ii) respective groups of multiple vCPUs 126A, 126N associated with each corresponding duplicate VM 121A, 121B of a set of two or more duplicate VMs. In some implementations, the hypervisor 110 can transmit the interrupt signal to a vCPU 126A, 126N to cause it to stop its current execution and process the interrupt. For example, a vCPU 126A, 126N can save its current execution state and can switch to kernel mode to handle the interrupt. The vCPU 126A, 126N can identify the type of interrupt (e.g., by reading the interrupt vector data and identifying the corresponding interrupt handler for the interrupt) and transfers control to the interrupt handler. The interrupt handler can perform the operations corresponding the transmitted interrupt based on interrupt handling instructions. In some implementations, the operations are performed with respect to the initial cryptographic secret. For example, in some implementations, the operations can include erasing the initial cryptographic secret, modifying the initial cryptographic secret, and generating a new cryptographic secret.

The hypervisor 110 can execute an operation with respect to the initial cryptographic secret. Initially, the hypervisor 110 can determine whether a triggering event has occurred or whether a threshold criterion has been satisfied. For example, a triggering event can include initiating the creation of the snapshot of the VM, executing one or more duplicate VMs, at least one VM 120 of the one or more duplicate VMs 121A, 121B being connected to a network 140, and receiving a request from at least one VM 120 of the one or more duplicate VMs 121A, 121B to establish secure communication. In some implementations, the triggering event can be provided by, and threshold condition can be satisfied by the occurrence of one or more of these circumstances. That is, in some implementations, the hypervisor 110 can undertake one or more operations with respect to the cryptographic secret. For example, in some implementations, the hypervisor 110 can erase the initial cryptographic secret. In the same or other implementations, the hypervisor 110 can modify the initial cryptographic secret. Further, in the same or other implementations, the hypervisor 110 can generate a new cryptographic secret. Accordingly, the hypervisor 110 can assign the new cryptographic secret to the duplicate VM 121A, 121B that does not have a cryptographic secret or replace the initial cryptographic secret with the new cryptographic secret in a VM 120 that had the initial cryptographic secret when it was first executed from the snapshot.

The hypervisor 110 can execute a virtual machine (VM) with an initial cryptographic secret identifying the VM. The initial cryptographic secret can be a random value generated by the hypervisor, a random value provided by another component of the host system 100, or a pseudorandom value. The cryptographic secret can be used to protect the confidentiality and integrity of the VM's data and communication. The hypervisor 110 can enforce the isolation and security of the VM 120 by preventing the unauthorized access and modification of the cryptographic secret. For example, the hypervisor 110 can use hardware-assisted virtualization features to isolate the VM's memory, I/O devices, and network interfaces. Thus, in some implementations, the hypervisor 110 can execute a VM 120 with an initial cryptographic secret identifying the VM 120. The hypervisor 110 can also assign multiple vCPUs 126A, 126N to the VM 10.

In some implementations, the hypervisor 110 can determine, for each vCPU 126A, 126N of a group of vCPUs, whether the vCPU 126A, 126N is registered to receive the interrupt. For example, the hypervisor 110 can maintain a data structure that associates each vCPU 126A, 126N with its interrupt registration status. The interrupt registration status can indicate whether the vCPU 126A, 126N is eligible to receive the interrupt or not. The hypervisor 110 can update the interrupt registration status based on the vCPUs 126A, 126N runtime state, such as its execution context and privilege level. For example, the hypervisor 110 can prevent a non-privileged vCPU 126A, 126N from receiving an interrupt that requires elevated privileges. In some implementations, this can include determining whether each vCPU 126A, 126N of a plurality of vCPUs 126A, 126N is registered to receive an interrupt. The hypervisor 110 can maintain a list of vCPUs 126A, 126N and their registration status for receiving interrupts. When an interrupt is to be sent, the hypervisor 110 can check the registration status of each vCPU 126A, 126N to determine whether it is eligible to receive the interrupt. If a vCPU 126A, 126N is eligible, the hypervisor 110 can multicast the interrupt to the vCPU.

Thus, in some implementations, the hypervisor 110 can multicast an interrupt to a plurality of vCPUs 126A, 126N of the VM, where the interrupt is associated with instructions to execute an operation with respect to the initial cryptographic secret. The hypervisor 110 can use a broadcast mechanism to deliver the interrupt to all eligible vCPUs 126A, 126N simultaneously. In other implementations, the interrupt can be associated in a set of interrupt handling instructions with a specific operation that modifies the cryptographic secret, such as erasing, modifying, or generating a new cryptographic secret. The hypervisor 110 can embed the instructions for the operation in the interrupt payload or the instructions can form part of a data structure accessed by an interrupt handler of the vCPU 126A, 126N upon receiving the interrupt.

In some implementations, the hypervisor 110 can multicast the interrupt to at least two vCPUs 126A, 126N of a group of vCPUs, responsive to determining that at least two vCPUs 126A, 126N of the plurality of vCPUs 126A, 126N are registered to receive the interrupt. In this manner, the hypervisor 110 can optimize the interrupt delivery by targeting the eligible vCPUs. If there is only one eligible vCPU, the hypervisor 110 can unicast the interrupt to that vCPU. If there are multiple eligible vCPUs, the hypervisor 110 can multicast the interrupt to those vCPUs.

In some implementations, the interrupt received by the vCPUs 126A, 126N can be associated with a variety of operations to be performed with respect to the initial cryptographic secret. For instance, these operations can include erasing the initial cryptographic secret, modifying the initial cryptographic secret, or generating a new cryptographic secret. Accordingly, multicasting the interrupt can prompt the hypervisor 110 to generate a new cryptographic secret for the VM 120 or its duplicate. For example, the hypervisor 110 can use a cryptographic random number generator to create a new secret value that is independent of the initial cryptographic secret. The new cryptographic secret can be used to replace or augment the initial cryptographic secret with additional security features. The hypervisor 110 can propagate the new cryptographic secret to the VM 120 and/or a duplicate VM 121A, 121B by updating the respective VM's memory and/or register state.

In the same or other implementations, after multicasting the interrupt, the hypervisor 110 can create a snapshot of the VM 120 so that one or more duplicate VMs 121A, 121B can be created from the snapshot. For example, the hypervisor 110 can create a snapshot of the VM's memory state by copying some or all of its memory contents to a designated location in the host system's memory. The snapshot can be used to clone or fork the VM 120 and its state in a fast and efficient manner. Accordingly, some implementations can include the hypervisor 110 creating a snapshot of the VM 120.

Thus, responsive to creating the snapshot, the hypervisor 110 can execute one or more duplicate VMs 121A, 121B from the snapshot of the VM. The hypervisor 110 can use the snapshot as a template to create exact replicas of the original VM 120 at the time the snapshot was taken. The hypervisor 110 can assign each duplicate VM 121A, 121B a unique identifier and allocate system resources to support its execution. The duplicate VMs 121A, 121B can be run on the same host system as the original VM 120 or on a different host system.

In some implementations, the hypervisor 110 can execute an operation based on the instructions associated with the interrupt. Whether or not an operation with respect to the initial cryptographic secret is performed can depend on determining whether a triggering event has occurred or whether a condition has been satisfied. For example, a triggering event can include initiating the creation of the snapshot of the VM 120, executing one or more duplicate VMs 121A, 121B, at least one VM 120 of the one or more duplicate VMs 121A, 121B being connected to a network 140, and at least one VM 120 of the one or more duplicate VMs 121A, 121B sending a request to establish secure communication. In the various implementations, triggering event can be provided by the occurrence of one or more of the foregoing events. Thus, in some implementations, the hypervisor 110 can determine whether a triggering event occurred and proceed to perform an operation associated with the interrupt received by the vCPUs 126A, 126N of the VM.

The interrupt can be associated with instructions to execute one or more operations including erasing the initial cryptographic secret, modifying the initial cryptographic secret, and generating a new cryptographic secret. In some implementations, the hypervisor 110 can perform one or more of these operations responsive to the triggering event. For example, in response to determining that a triggering event occurred, the hypervisor 110 can erase the initial cryptographic secret. Analogously, in another example in response to determining that a triggering event occurred, the hypervisor 110 can modify the initial cryptographic secret. Similarly, whether in addition to or instead of performing the operations of erasing or modifying, in response to determining that a triggering event occurred, the hypervisor 110 can generate a new cryptographic secret and replace the initial cryptographic secret with a new cryptographic secret.

In some of the various implementations, the new cryptographic secret can be generated by an operation of the VM, an operation of a duplicate VM, an operation of the hypervisor, or a combined operation of the hypervisor 110 and either the VM 120 or the duplicate VM. For example, the hypervisor 110 can generate the new cryptographic secret by an operation of the VM 120 in this situation where the multicast interrupt was sent prior to any duplicate VM 121A, 121B being executed from the snapshot of the VM. In other examples, the hypervisor 110 can generate the new cryptographic secret by an operation of the duplicate VM 121A, 121B in situations when a duplicate VM 121A, 121B has been executed from the snapshot. In some other examples, the hypervisor 110 can generate a new cryptographic secret through the operation of the hypervisor, or a combined operation of the hypervisor 110 and either the VM 120 or the duplicate VM. In some cases, the new cryptographic secret can be generated by applying a cryptographic algorithm to a seed value or to an existing cryptographic secret. The seed value can be a random value or a predetermined value and can be generated internally by the hypervisor 110 or provided externally. The cryptographic algorithm can be a symmetric or asymmetric encryption algorithm, a hash function, or another suitable cryptographic algorithm.

In some implementations, the new cryptographic secret can be used to establish a secure communication channel between the VM 120 or between the duplicate VM 121A, 121B and another system or device. The secure communication channel can be used to exchange sensitive information or perform secure transactions. The new cryptographic secret can also be used to protect the confidentiality, integrity, and authenticity of data stored or processed by the VM 120 or the duplicate VM. In some implementations, the new cryptographic secret can be periodically updated or refreshed to enhance the security of the VM 120 or the duplicate VM.

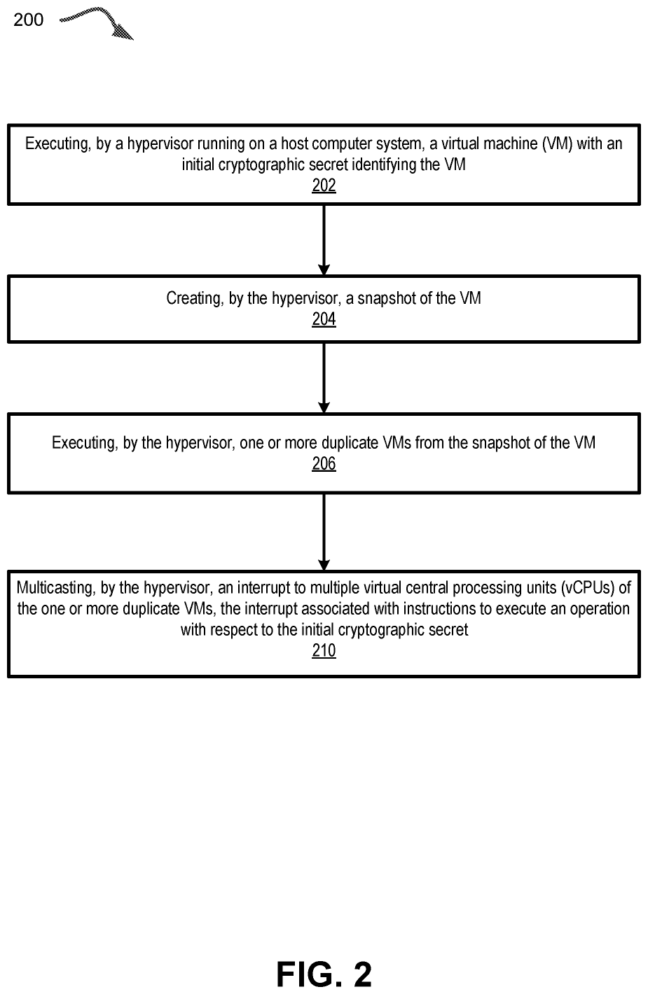

FIG. 2 is a flow diagram of an example method for protecting a cryptographical secret of a virtual machine, in accordance with one or more aspects of the present disclosure. Method 200 can be performed by processing logic that includes hardware (e.g., circuitry, dedicated logic, programmable logic, microcode, etc.), software (e.g., instructions run on a processor to perform hardware simulation), or a combination thereof. Method 200 or each of its individual functions, routines, subroutines, or operations can be performed by one or more processors of a computer system (e.g., the computer system 100 of FIG. 1) implementing the method. In an illustrative example, method 200 may be performed by a single processing thread. Alternatively, method 200 can be performed by two or more processing threads, each thread implementing one or more individual functions, routines, subroutines, or operations of the method. In an illustrative example, the processing threads implementing method 200 can be synchronized (e.g., using semaphores, critical sections, or other thread synchronization mechanisms). Alternatively, the processing threads implementing method 200 can be executed asynchronously with respect to each other. Therefore, while FIG. 2 and the associated description lists the operations of method 200 in certain order, various implementations of the method can perform at least some of the described operations in parallel or in arbitrary selected orders.

In some implementations, at block 202, the processing logic (e.g., the processing logic that generates or represents the hypervisor 110) can execute a virtual machine and assign one or more virtual central processing units (vCPUs) to the virtual machine. This can include the processing logic executing, by a hypervisor running on a host computer system, a virtual machine (VM) with an initial cryptographic secret that identifies the VM. The processing logic can, at block 204, create, a snapshot of the VM. At block 206, the processing logic can execute, one or more duplicate VMs from the snapshot of the VM. In some implementations, the processing logic, can then at block 210, multicast an interrupt to multiple vCPUs of the duplicate VMs. The interrupt can be associated (e.g., in a data structure referenced by an interrupt handler) with instructions to execute an operation with respect to the initial cryptographic secret. In some implementations, additional operations and actions can be performed before the processing logic multicasts the interrupt.

In some implementations, at block 202, the processing logic (e.g., the processing logic that generates or represents the hypervisor 110) can execute a VM and assign it multiple vCPUs. The execution of the VM can include the processing logic selecting an appropriate VM configuration, selecting an appropriate number of vCPUs to assign to the VM, and assigning an initial cryptographic secret to the VM. In these or other implementations, at block 204, the processing logic can create a snapshot of the VM at a predetermined time. The processing logic creating the snapshot can include copying the memory contents of the VM, including its RAM, cache, and base image (e.g., backing store), to a designated location in the host system's memory. The snapshot can be used as a template to create one or more duplicate VMs. Thus, at block 206, the processing logic can execute one or more duplicate VMs from the snapshot of the VM. This can include the processing logic selecting a specified number of vCPUs to assign to each duplicate VM, copying the memory contents of the snapshot to each duplicate VM, and configuring each duplicate VM.

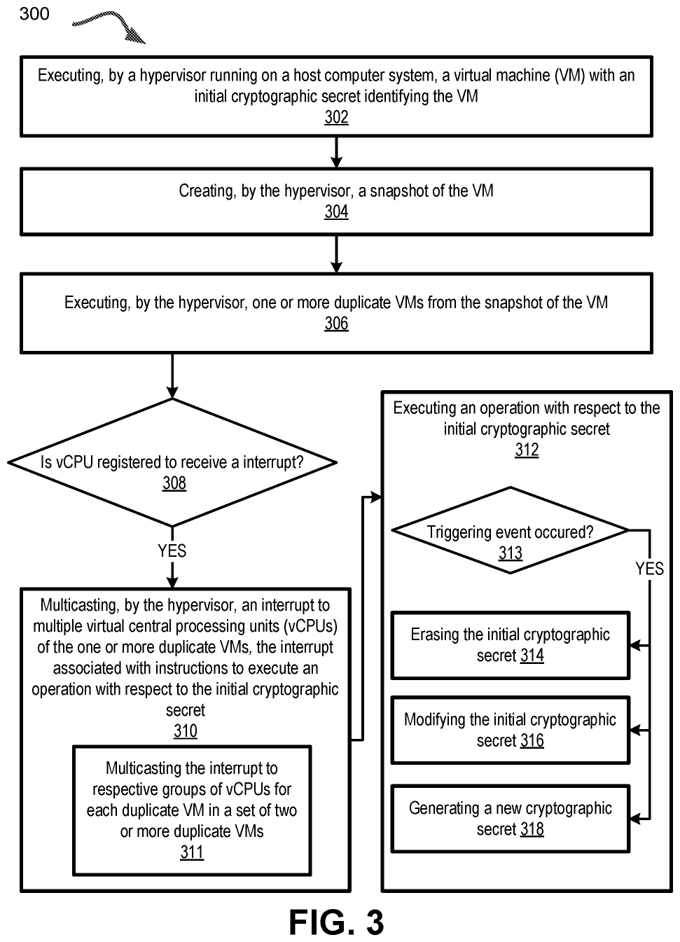

In these or other implementations, the processing logic can then, at block 210, multicast an interrupt to multiple vCPUs of at least one of the duplicate VMs. This can include the processing logic determining which vCPUs are registered to receive the interrupt, and multicasting the interrupt to those vCPUs that are registered. The interrupt can be associated with instructions to execute an operation with respect to the initial cryptographic secret, such as erasing or modifying the initial cryptographic secret or generating a new cryptographic secret. The transmission of the interrupt as well as the subsequent execution of the associated operation can also be triggered by a triggering event, such the initiation of the creation of the VM snapshot, the execution of a duplicate VM, the connection of a VM to a network, or the transmission of a request to establish secure communication. In some implementations, the new cryptographic secret can be generated by an operation of the VM, an operation of a duplicate VM, an operation of the hypervisor, or a combined operation of the hypervisor and either the VM or the duplicate VM. Some of these operations can be understood in more detail with reference to FIG. 3.

FIG. 3 is a flow diagram of an example method for protecting a cryptographical secret of a virtual machine, in accordance with one or more aspects of the present disclosure. Method 300 can be performed by processing logic that includes hardware (e.g., circuitry, dedicated logic, programmable logic, microcode, etc.), software (e.g., instructions run on a processor to perform hardware simulation), or a combination thereof. Method 300 or each of its individual functions, routines, subroutines, or operations can be performed by one or more processors of a computer system (e.g., the computer system 100 of FIG. 1) implementing the method. In an illustrative example, method 300 can be performed by a single processing thread. Alternatively, method 300 can be performed by two or more processing threads, each thread implementing one or more individual functions, routines, subroutines, or operations of the method. In an illustrative example, the processing threads implementing method 300 can be synchronized (e.g., using semaphores, critical sections, or other thread synchronization mechanisms). Alternatively, the processing threads implementing method 300 can be executed asynchronously with respect to each other. Therefore, while FIG. 3 and the associated description lists the operations of method 300 in certain order, various implementations of the method can perform at least some of the described operations in parallel or in arbitrary selected orders.

Events and operations occurring within the various blocks of method 300 can occur, in some implementations, in any order as well as together with or instead of events and operations occurring within the various blocks of method 200 described earlier. For example, method 300 can begin at block 302, where the processing logic (e.g., the processing logic that generates or represents the hypervisor 110) can create (one or more) VMs. This can include the processing logic executing, by a hypervisor running on a host computer system, a VM with an initial cryptographic secret identifying the VM. at block 302, the processing logic can assign the VM multiple virtual central processing units (vCPUs). The initial cryptographic secret can be used to secure and authenticate the VM and its associated resources. The initial cryptographic secret can be any type of encryption key, such as a symmetric or asymmetric key, used to secure data communications within the VM. For example, the initial cryptographic secret can be a randomly generated value that is securely stored and used for subsequent encryption and decryption of data within the VM. The initial cryptographic secret can also be associated with an identifier that uniquely identifies the VM. In the same or other implementations, at block 304, the processing logic can (e.g., by the hypervisor), create a snapshot of the VM. The snapshot can be a point-in-time copy of the VM's state, including its memory, registers, and other state information. The snapshot can be used to create one or more duplicate VMs that are exact copies of the original VM or duplicate VMs that are slightly modified versions of the original VM.

Accordingly, the processing logic can, at block 306, execute one or more duplicate VMs from the snapshot of the VM. The duplicate VMs can, in some instances, be exact copies of the original VM and can include its initial cryptographic secret, while in other instances, they can be modified copies of the original VM and have different cryptographic secrets Then the original VM. Then, having created one or more duplicate VMS, the processing logic can, at block 308, determining, for each vCPU assigned to the VM, whether the vCPU is registered to receive the interrupt. Determining which vCPU of a group of vCPUs or whether a particular vCPU is registered to receive the interrupt can be useful to prevent unnecessary overhead caused by multicasting the interrupt to vCPUs that do not require it or are not capable of properly interpreting it. This can improve the efficiency of the system by reducing the amount of unnecessary processing and communications that occur. In some implementations, the processing logic can maintain a data structure that tracks which vCPUs are registered to receive the interrupt. When an interrupt is generated, the processing logic (e.g., via the hypervisor) can consult this data structure to determine which vCPUs to multicast the interrupt to, based on their registration status. This can help ensure that only the necessary vCPUs receive the interrupt, while minimizing overhead and resource utilization.

Accordingly, at block 310, the processing logic can multicast (e.g., via the hypervisor) an interrupt to one or more vCPUs of the one or more duplicate VMs That were created from the snapshot at block 306. In some implementations, the interrupt can be associated with instructions to execute an operation with respect to the initial cryptographic secret. In this manner, the interrupt can be used to modify, erase, or generate a new cryptographic secret. The multicasting of the interrupt can ensure that the operation is executed simultaneously on all vCPUs that are registered to receive the interrupt, thereby ensuring that the cryptographic secret is updated consistently. For example, responsive to determining, at block 308, that at least two vCPUs of the vCPUs that were assigned to a duplicate VM are registered to receive the interrupt, the processing logic can, at block 311, multicast the interrupt to those vCPUs. Accordingly, in some implementations, at block 311, the processing logic can multicast the interrupt to respective groups of multiple vCPUs associated with each corresponding duplicate VM of a set of two or more duplicate VMs. In other implementations, the processing logic can, at block 311, multicast the interrupt to (i) one or more vCPUs for the VM and to (ii) respective groups of multiple vCPUs associated with each corresponding duplicate VM of a set of two or more duplicate VMs. In some implementations, the processing logic can transmit the interrupt signal to a vCPU to cause it to stop its current execution and process the interrupt. For example, vCPU can save its current execution state and can switch to kernel mode to handle the interrupt. The vCPU can identify the type of interrupt (e.g., by reading the interrupt vector (data) and identifying the corresponding interrupt handler for the interrupt) and transfers control to the interrupt handler. The interrupt handler can perform the operations corresponding the transmitted interrupt based on interrupt handling instructions. In some implementations the operations are performed with respect to the initial cryptographic secret. For example, in some implementations, the operations can include erasing the initial cryptographic secret, modifying the initial cryptographic secret, and generating a new cryptographic secret.

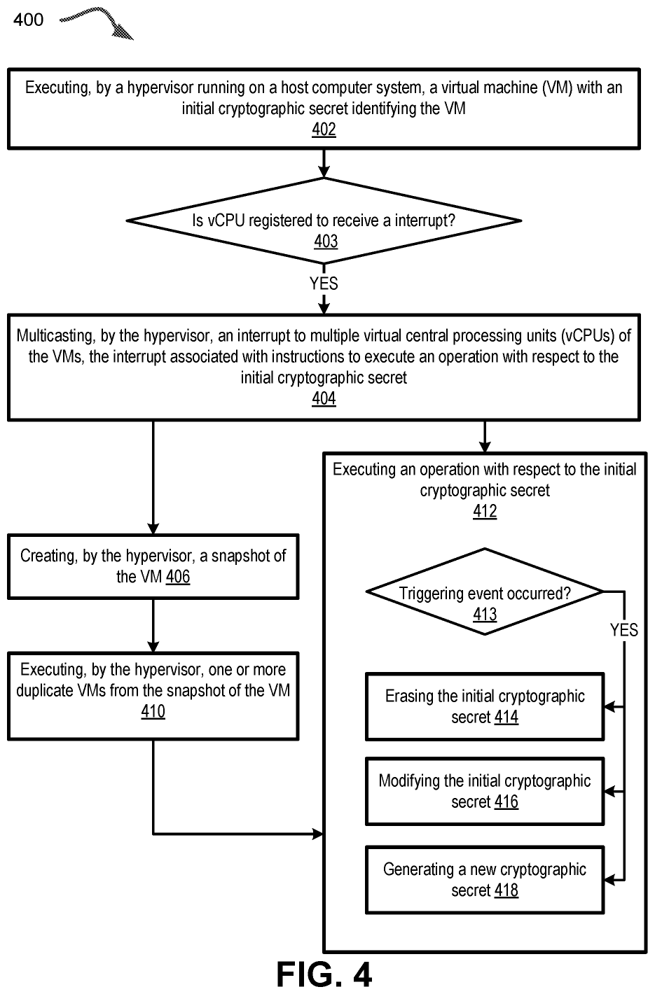

At block 312, the processing logic can execute an operation with respect to the initial cryptographic secret. Initially, the processing logic can determine, at block 313, whether a triggering event has occurred or whether a threshold criterion has been satisfied. For example, a triggering event can include initiating the creation of the snapshot of the VM, executing one or more duplicate VMs, at least one VM of the one or more duplicate VMs being connected to a network, and receiving a request from at least one VM of the one or more duplicate VMs to establish secure communication. In some implementations, the threshold condition can be satisfied by the occurrence of one or more of the foregoing circumstances. That is, in some implementations, the processing logic can undertake one or more operations with respect to the cryptographic secret. For example, in some implementations, the processing logic can, at block 314, erase the initial cryptographic secret. In the same or other implementations, at block 316, the processing logic can modify the initial cryptographic. Further, in the same or other implementations, the processing logic can, at block 318, generate a new cryptographic secret. Accordingly, the processing logic can (e.g., by the hypervisor), assign the new cryptographic secret to the duplicate VM that does not have a cryptographic secret or replace the initial cryptographic secret with the new cryptographic secret in a VM that had the initial cryptographic secret upon being executed from the snapshot. These and other aspects of the present disclosure can be better understood with reference to FIG. 4.

FIG. 4 is a flow diagram of an example method of communication for an encrypted virtual machine, in accordance with one or more aspects of the present disclosure. Method 400 can be performed by processing logic that includes hardware (e.g., circuitry, dedicated logic, programmable logic, microcode, etc.), software (e.g., instructions run on a processor to perform hardware simulation), or a combination thereof. Method 300 or each of its individual functions, routines, subroutines, or operations can be performed by one or more processors of a computer system (e.g., the computer system 100 of FIG. 1) implementing the method. In an illustrative example, method 400 can be performed by a single processing thread. Alternatively, method 300 can be performed by two or more processing threads, each thread implementing one or more individual functions, routines, subroutines, or operations of the method. In an illustrative example, the processing threads implementing method 400 can be synchronized (e.g., using semaphores, critical sections, or other thread synchronization mechanisms). Alternatively, the processing threads implementing method 400 can be executed asynchronously with respect to each other. Therefore, while FIG. 4 and the associated description lists the operations of method 400 in certain order, various implementations of the method can perform at least some of the described operations in parallel or in arbitrary selected orders.

Events and operations occurring within the various blocks of method 400 can occur, in some implementations, in any order as well as together with or instead of events and operations occurring within the various blocks of methods 200 and 300 described earlier. For example, method 400 can begin at block 402, where the processing logic (e.g., the processing logic that generates or represents the hypervisor 110) can execute a virtual machine (VM) with an initial cryptographic secret identifying the VM. The initial cryptographic secret can be a random value generated by the hypervisor, provided by another component of the system, or a pseudorandom value. The cryptographic secret can be used to protect the confidentiality and integrity of the VM's data and communication. The processing logic can enforce the isolation and security of the VM by preventing the unauthorized access and modification of the cryptographic secret. For example, the processing logic can use hardware-assisted virtualization features to isolate the VM's memory, I/O devices, and network interfaces. Thus, in some implementations, block 402 can include the processing logic executing, by a hypervisor running on a host computer system, a VM with an initial cryptographic secret identifying the VM. At block 402, the processing logic can also assign multiple vCPUs to the VM.

In some implementations, at block 403, the processing logic can (e.g., by the hypervisor), determine, for each vCPU of the plurality of vCPUs, whether the vCPU is registered to receive the interrupt. For example, the processing logic can maintain a data structure that associates each vCPU with its interrupt registration status. The interrupt registration status can indicate whether the vCPU is eligible to receive the interrupt or not. The processing logic can update the interrupt registration status based on the vCPU's runtime state, such as its execution context and privilege level. For example, the processing logic can prevent a non-privileged vCPU from receiving an interrupt that requires elevated privileges. In some implementations, this can include the processing logic determining whether each vCPU of a plurality of vCPUs is registered to receive an interrupt. The processing logic can maintain a list of vCPUs and their registration status for receiving interrupts. When an interrupt is to be sent, the processing logic can check the registration status of each vCPU to determine whether it is eligible to receive the interrupt. If a vCPU is eligible, the processing logic can multicast the interrupt to the vCPU.

Thus, in some implementations, at block 404, the processing logic can multicast an interrupt to a plurality of vCPUs of the VM, where the interrupt is associated with instructions to execute an operation with respect to the initial cryptographic secret. The processing logic can use a broadcast mechanism to deliver the interrupt to all eligible vCPUs simultaneously. And these are other implementations, the interrupt can be associated in a set of interrupt handling instructions with a specific operation that modifies the cryptographic secret, such as erasing, modifying, or generating a new cryptographic secret. The processing logic can embed the instructions for the operation in the interrupt payload or the instructions can form part of a data structure accessed by an interrupt handler of the vCPU upon receiving the interrupt.

In some implementations, at block 404, the processing logic can multicast the interrupt to at least two vCPUs of the plurality of vCPUs, responsive to determining, at block 403, that at least two vCPUs of the plurality of vCPUs are registered to receive the interrupt. In this manner, the processing logic can optimize the interrupt delivery by targeting only the eligible vCPUs. If there is only one eligible vCPU, the processing logic can unicast the interrupt to that vCPU. If there are multiple eligible vCPUs, the processing logic can multicasts the interrupt to those vCPUs. Thus, in some implementations, responsive to determining, at block 403, that at least two vCPUs are registered to receive the interrupt, at block 404, the processing logic can multicast the interrupt to those vCPUs.

In some implementations, the interrupt can be associated with instructions to execute a variety of operations with respect to the initial cryptographic secret. For example, the operations can include erasing the initial cryptographic secret, modifying the initial cryptographic secret, and generating a new cryptographic secret. Thus, in these implementations or other implementations, multicasting the interrupt can cause a new cryptographic secret to be generated for the VM. similarly, multicasting the interrupt can also cause a new cryptographic secret to be generated a duplicate VM. For example, the processing logic can generate a new cryptographic secret for the VM (or for a duplicate VM), in response to multicasting the interrupt. In some instances, the processing logic (e.g., via the hypervisor) can use a cryptographic random number generator to create a new secret value that is independent of the initial cryptographic secret. The processing logic can use the new cryptographic secret to replace the initial cryptographic secret or to augment it with additional security features. The processing logic can propagate the new cryptographic secret to the VM and/or its duplicates by updating their memory and/or register state.

In the same or other implementations, after multicasting the interrupt, the processing logic can create a snapshot of the VM and execute one or more duplicate VMs from the snapshot of the VM. In some implementations, at block 406, the processing logic can create a snapshot of the VM. For example, the processing logic (e.g., via the hypervisor) can create a snapshot of the VM's memory state by copying some or all of its memory contents to a designated location in the host system's memory. In some instances, the snapshot can capture the entire memory hierarchy of the VM, including its RAM, cache, and backing store. in other instances, the snapshot can be used to capture this information partially. The snapshot can be used to clone or fork the VM and its state in a fast and efficient manner. Accordingly, some implementations can include, at operation 406, the processing logic creating, by the hypervisor, a snapshot of the VM.

Having created the snapshot, at block 406, the processing logic (e.g., via the hypervisor) can, at block 410, execute one or more duplicate VMs from the snapshot of the VM. The processing logic can use the snapshot as a template to create one or more duplicate VMs that are exact replicas of the original VM at the time the snapshot was taken. The processing logic can assign each duplicate VM a unique identifier and allocate system resources to support its execution. The duplicate VMs can be run on the same host system as the original VM or on a different host system.

In some implementations, the processing logic can, at block 412, execute an operation on based on the instructions associated with the interrupt. In some implementations, Whether or not an operation with respect to the initial cryptographic secret is performed can depend on determining whether or not a triggering event has occurred or whether a condition has been satisfied. For example, a triggering event can include initiating the creation of the snapshot of the VM, executing one or more duplicate VMs, at least one VM of the one or more duplicate VMs being connected to a network, and at least one VM of the one or more duplicate VMs sending a request to establish secure communication. Thus, in some implementations, at block 413, the processing logic can determine whether a triggering event occurred and proceed, at block 412, to perform an operation associated with the interrupt received by the vCPUs of the VM.

The interrupt can be associated with instructions to execute one or more operations including erasing the initial cryptographic secret, modifying the initial cryptographic secret, and generating a new cryptographic secret, in some implementations, the processing logic can perform one or more of these operations responsive to the triggering event. For example, in response to determining at block 413 that a triggering event occurred, the processing logic can, at block 414, erase the initial cryptographic secret. Analogously, in another example in response to determining at block 413 that a triggering event occurred, the processing logic can, at block 416, modify the initial cryptographic secret. Similarly, whether in addition to or instead of performing the operations of block 414 or block 416, in response to determining at block 413 that are triggering event occurred, the processing logic can, at block 418 generate a new cryptographic secret and replace the initial cryptographic secret with a new cryptographic secret.

in some of the various implementations, the new cryptographic secret can be generated by an operation of the VM, an operation of a duplicate VM, an operation of the hypervisor, or a combined operation of the hypervisor and either the VM or the duplicate VM. For example, at block 418, the processing logic can generate the new cryptographic secret by an operation of the VM in this situation where the multicast interrupt was sent prior to any duplicate VM being executed from the snapshot of the VM. In other examples, at block 418, the processing logic can generate the new cryptographic secret by an operation of the duplicate VM in situations when a duplicate VM has been executed from the snapshot. And yet other examples, that operation for 18, the processing logic can generate a new cryptographic secret through the operation of the hypervisor, or a combined operation of the hypervisor and either the VM or the duplicate VM. In some cases, the new cryptographic secret can be generated by applying a cryptographic algorithm to a seed value or to an existing cryptographic secret. The seed value can be a random value or a predetermined value and can be generated internally by the hypervisor or provided externally. The cryptographic algorithm can be a symmetric or asymmetric encryption algorithm, a hash function, or another suitable cryptographic algorithm.

In some implementations, the new cryptographic secret can be used to establish a secure communication channel between the VM or between the duplicate VM and another system or device. The secure communication channel can be used to exchange sensitive information or perform secure transactions. The new cryptographic secret can also be used to protect the confidentiality, integrity, and authenticity of data stored or processed by the VM or the duplicate VM. In some implementations, the new cryptographic secret can be periodically updated or refreshed to enhance the security of the VM or the duplicate VM.

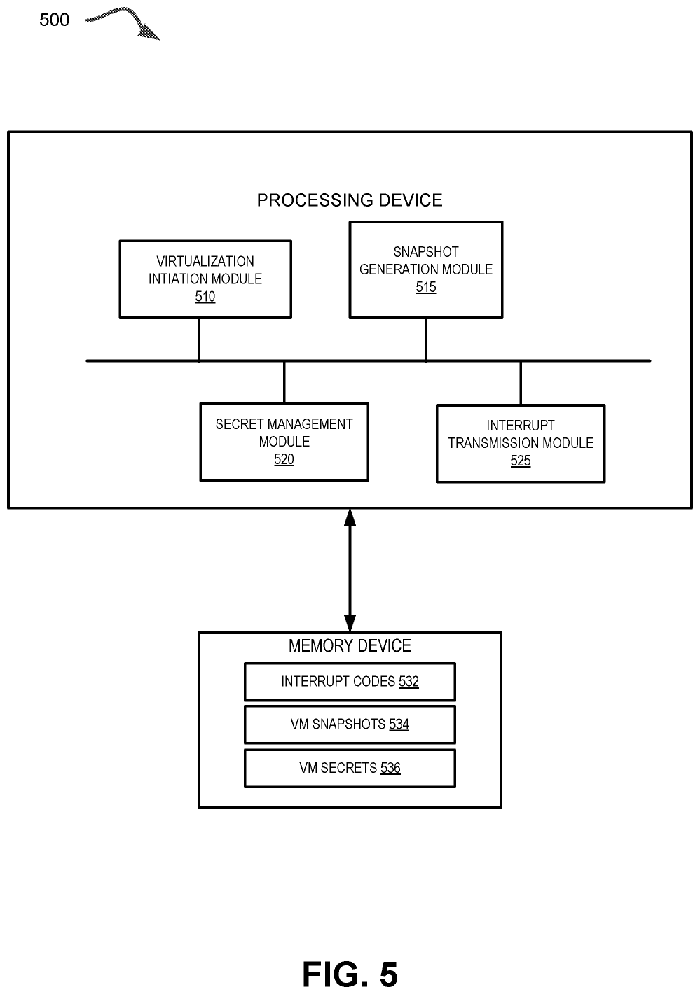

FIG. 5 depicts a block diagram of a computer system 500 operating in accordance with one or more aspects of the present disclosure. Computer system 500 may be the same or similar to computer system 100 of FIG. 1 or computer system 700 of FIG. 7 and may include one or more processing devices and one or more memory devices. In the example shown, computer system 500 may include an access a virtualization initiation module 510, a snapshot generation module 515, a secret management module 520, and an interrupt transmission module 525 along with a memory device that can store interrupt codes 532, VM snapshots 534, and VM secrets 536 (e.g., secret cryptographic values).

In some implementations, virtualization initiation module 510 can enable the processing device (e.g., via hypervisor) to create one or more VMs and one or more virtual devices. It can further enable the processor to allocate certain physical hardware resources to the VMs and associate virtual devices with hardware devices. In some implementations, the snapshot generation module 515 can enable the processor to create a snapshot 534 of a VM and store it on the memory device.

In some implementations, the secret management module 520 can enable the processing device to create, track, assign, and monitor one or more cryptographic secrets 536 used by one or more vCPUs of a VM or a duplicate VM. Further, the secret management module 520 can enable the processing device to determine whether any VMs have access to the same cryptographic secret 536.

In some implementations, an interrupt transmission module 525 can enable the processor (e.g. by the hypervisor) to determine the vCPUs registered to receive an interrupt and to multicast an interrupt to those vCPUs. The interrupt can be associated with an interrupt code 532 that can have corresponding instructions to perform one or more operations with respect to a cryptographic value being used by a vCPU.

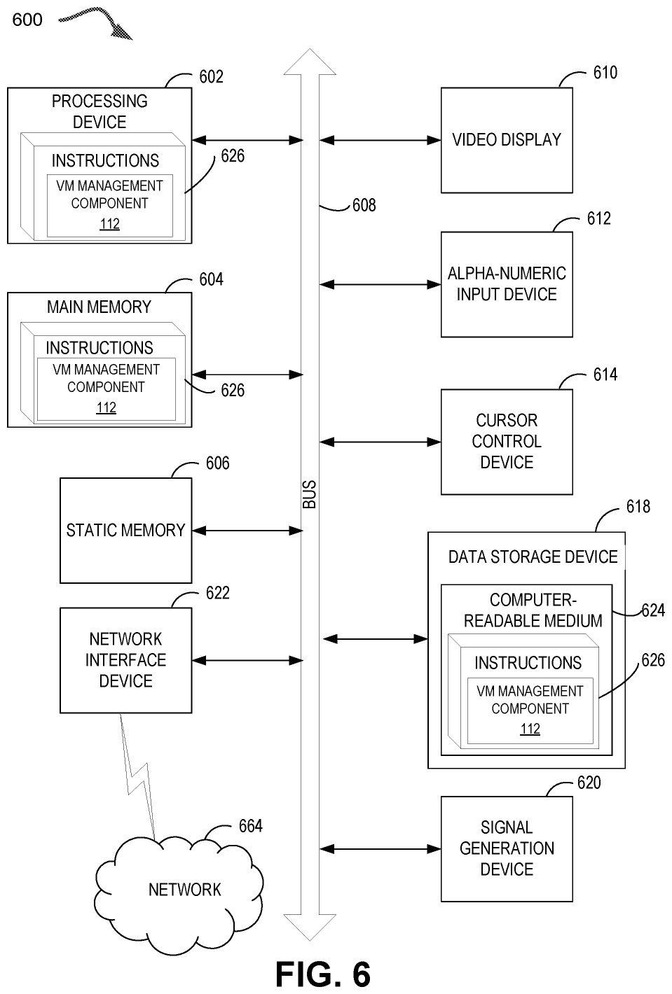

FIG. 6 depicts a block diagram of a computer system operating in accordance with one or more aspects of the disclosure. In various illustrative examples, computer system 600 can correspond to computer system 100 of FIG. 1 or computer system 500 of FIG. 5. The computer system 600 can be included within a data center that supports virtualization. Virtualization within a data center results in a physical system being virtualized using VMs and/or containerized applications to consolidate the data center infrastructure and increase operational efficiencies. A VM can be a program-based emulation of computer hardware. For example, the VM can operate based on computer architecture and functions of computer hardware resources associated with hard disks or other such memory. The VM can emulate a physical computing environment, but requests for a hard disk or memory can be managed by a virtualization layer of a host system to translate these requests to the underlying physical computing hardware resources. This type of virtualization results in multiple VMs sharing physical resources.

In certain implementations, computer system 600 can be connected (e.g., via a network, such as a Local Area Network (LAN), an intranet, an extranet, or the Internet) to other computer systems. Computer system 600 can operate in the capacity of a server or a client computer in a client-server environment, or as a peer computer in a peer-to-peer or distributed network environment. Computer system 600 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 can include a processing device 602, a volatile memory 604 (e.g., random access memory (RAM)), a non-volatile memory 606 (e.g., read-only memory (ROM) or electrically-erasable programmable ROM (EEPROM)), and a data storage device 618, which can communicate with each other via a bus 608.

Processing device 602 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 can further include a network interface device 608. Computer system 600 also can include a video display unit 610 (e.g., an LCD), an alphanumeric input device 612 (e.g., a keyboard), a cursor control device 614 (e.g., a mouse), and a signal generation device 616.

Data storage device 618 can include a non-transitory computer-readable storage medium 624 on which can store instructions 626 embodying any one or more of the methodologies or functions described herein (e.g., VM management component 112 of FIG. 1, and methods 200, 300, and 400 of FIGS. 2, 3, and 4 respectively). Instructions 626 can also reside, completely or partially, within volatile memory 604 and/or within processing device 602 during execution thereof by computer system 600, hence, volatile memory 604 and processing device 602 can also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs, or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “associating,” “deleting,” “initiating,” “marking,” “generating,” “recovering,” “completing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus can be specially constructed for performing the methods described herein, or it can comprise a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods 200, and 300, and/or each of their individual functions, routines, subroutines, or operations. Examples of the structure for a variety of these systems are set forth in the description above.

The above description is intended to be illustrative, and not restrictive. Although the disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
executing, by a hypervisor running on a host computer system, a virtual machine (VM) with an initial cryptographic secret identifying the VM;
creating, by the hypervisor, a snapshot of the VM;
executing, by the hypervisor, one or more duplicate VMs from the snapshot of the VM; and
multicasting, by the hypervisor, an interrupt to a plurality of virtual central processing units (vCPUs) of the one or more duplicate VMs, the interrupt associated with instructions to execute an operation with respect to the initial cryptographic secret.

2. The method of claim 1, wherein the operation comprises at least one of erasing the initial cryptographic secret, modifying the initial cryptographic secret, and generating a new cryptographic secret.

3. The method of claim 1, wherein multicasting the interrupt to the plurality of vCPUs of the one or more duplicate VMs comprises:
multicasting the interrupt to respective pluralities of vCPUs for each duplicate VM of a set of two or more duplicate VMs; or
multicasting the interrupt to a plurality of vCPUs for the VM and to respective pluralities of vCPUs for each duplicate VM of a set of two or more duplicate VMs.

4. The method of claim 1, further comprising:
determining, for each vCPU of the plurality of vCPUs, whether the vCPU is registered to receive the interrupt; and
responsive to determining that at least two vCPUs of the plurality of vCPUs are registered to receive the interrupt, multicasting the interrupt to the at least two vCPUs.

5. The method of claim 1, wherein multicasting the interrupt causes a new cryptographic secret to be generated for a duplicate VM of the one or more duplicate VMs.

6. The method of claim 5, wherein the new cryptographic secret is generated responsive to a triggering event, the triggering event provided by one of:
executing the one or more duplicate VMs;
at least one VM of the one or more duplicate VMs being connected to a network; and
at least one VM of the one or more duplicate VMs sending a request to establish secure communication.

7. The method of claim 5, wherein the new cryptographic secret is generated by an operation of a duplicate VM of the one or more duplicate VMs, an operation of the hypervisor, or a combined operation of the hypervisor and the duplicate VM.

8. A system comprising:
a memory device;
a processing device operatively coupled to the memory device, to perform operations comprising:
executing, by a hypervisor running on a host computer system, a virtual machine (VM) with an initial cryptographic secret identifying the VM;
creating, by the hypervisor, a snapshot of the VM;
executing, by the hypervisor, one or more duplicate VMs from the snapshot of the VM; and
multicasting, by the hypervisor, an interrupt to a plurality of virtual central processing units (vCPUs) of the one or more duplicate VMs, the interrupt associated with instructions to execute an operation with respect to the initial cryptographic secret.

9. The system of claim 8, wherein the interrupt is associated with instructions to execute the operation comprising at least one of: erasing the initial cryptographic secret, modifying the initial cryptographic secret, and generating a new cryptographic secret.

10. The system of claim 8, wherein multicasting the interrupt to the plurality of vCPUs of the one or more duplicate VMs comprises multicasting the interrupt to respective pluralities of vCPUs for each duplicate VM of a set of two or more duplicate VMs.

11. The system of claim 8, wherein the operations further comprise:
determining, for each vCPU of the plurality of vCPUs, whether the vCPU is registered to receive the interrupt; and
responsive to determining that at least two vCPUs of the plurality of vCPUs are registered to receive the interrupt, multicasting the interrupt to the at least two vCPUs.

12. The system of claim 8, wherein multicasting the interrupt causes a new cryptographic secret to be generated for a duplicate VM of the one or more duplicate VMs.

13. The system of claim 12, wherein the new cryptographic secret is generated responsive to a triggering event, the triggering event provided by one of:
executing the one or more duplicate VMs;
at least one VM of the one or more duplicate VMs being connected to a network; and
at least one VM of the one or more duplicate VMs sending a request to establish secure communication.

14. The system of claim 12, wherein the new cryptographic secret is generated by an operation of a duplicate VM of the one or more duplicate VMs, an operation of the hypervisor, or a combined operation of the hypervisor and the duplicate VM.

15. A non-transitory computer-readable media storing instructions that, when executed, cause a processing device to perform operations comprising:
executing, by a hypervisor running on a host computer system, a virtual machine (VM) with an initial cryptographic secret identifying the VM;
multicasting, by the hypervisor, an interrupt to a plurality of virtual central processing units (vCPUs) of the VM, the interrupt associated with instructions to execute an operation with respect to the initial cryptographic secret;
creating, by the hypervisor, a snapshot of the VM; and
executing, by the hypervisor, one or more duplicate VMs from the snapshot of the VM.

16. The non-transitory computer-readable media of claim 15, wherein the interrupt is associated with instructions to execute the operation comprising at least one of: erasing the initial cryptographic secret, modifying the initial cryptographic secret, and generating a new cryptographic secret.

17. The non-transitory computer-readable media of claim 15, wherein the operations further comprise:
determining, for each vCPU of the plurality of vCPUs, whether the vCPU is registered to receive the interrupt; and
responsive to determining that at least two vCPUs of the plurality of vCPUs are registered to receive the interrupt, multicasting the interrupt to the at least two vCPUs.

18. The non-transitory computer-readable media of claim 15, wherein multicasting the interrupt causes a new cryptographic secret to be generated for the VM.

19. The non-transitory computer-readable media of claim 18, wherein the new cryptographic secret is generated responsive to a triggering event, the triggering event provided by one of:
initiating a creation of the snapshot of the VM;
executing the one or more duplicate VMs;
at least one VM of the one or more duplicate VMs being connected to a network; and
at least one VM of the one or more duplicate VMs sending a request to establish secure communication.

20. The non-transitory computer-readable media of claim 18, wherein the new cryptographic secret is generated by an operation of the VM, an operation of a duplicate VM of the one or more duplicate VMs, an operation of the hypervisor, or a combined operation of the hypervisor and either the VM or the duplicate VM.
